(19) United States
(12) Patent Application Publication
(10) Pub. No.: US 2024/0365723 A1
(43) Pub. Date: Nov. 7, 2024

(54) PLANTER ASSEMBLY FOR HEADSTONE

(71) Applicant: James S. Blahowicz, Hamburg, NY (US)

(72) Inventor: James S. Blahowicz, Hamburg, NY (US)

(21) Appl. No.: 18/311,365

(22) Filed: May 3, 2023

(51) Int. Cl. A01G 9/02

(52) U.S. Cl. CPC A01G 9/02

(57) ABSTRACT

A removable planter assembly for a headstone comprising a planter including a floor and at least one wall extending from the floor forming a container portion therein, a holster extending from the floor, a U-shaped clamp extending from an outside surface of the at least one wall, the U-shape clamp having a mounting member secured to the at least one wall and a pair of arms extending from the mounting member, one of the pair of arms having at least one fixed securement mechanism secured thereon, the at least one fixed securement mechanism arranged proximate a terminating end of the arm, one of the pair of arms having at least one adjustable securement mechanism secured therein, the at least one adjustable securement mechanism arranged proximate a terminating end of the arm, and a support stand extending from an external surface of the floor.

### FIELD

The present invention relates to a removable planter assembly for a headstone, specifically a planter assembly having a clamp arranged to removably secure the assembly to the headstone.

### BACKGROUND

Presently, headstones, or memorial stones, typically comprise a base member and a headstone marker. In many arrangements, the base member can extend past the external perimeter of the headstone, forming a lip or shelf that may extend past the external perimeter of the headstone marker. This lip or shelf is traditionally only a few inches wide. Because of this relatively small width, the lip or shelf on the base surrounding the headstone does not provide adequate surface area for planters, or decorations, to rest upon. In many cases, when planters or decorations are placed on this lip or shelf, they seldomly remain in that position, either due to weather, such as wind/rain/snow, either tipping over or becoming damaged. In other cases, the lip or shelf of the base is entirely too small to support decorations or planters, usually requiring the planter or decoration to be placed on the ground. Therefore, there is a long-felt need for a removable container that can be attached directly to the headstone marker in a removable and adjustable manner.

Headstones are traditionally made from granite, marble, ceramic, and sometimes bronze. These headstones are expensive, ranging in cost from one-thousand to even more than ten-thousand dollars. The headstone also may include stylized text, symbols, and sometimes pictures. Due to the high expense, it is desired to decorate the headstone site in a manner that does not damage the headstone.

U.S. Pat. No. 5,435,099 discloses a container assembly arranged for attaching to a front, side, and rear surface of a headstone. The '099 patent teaches a container assembly apparatus arranged to attach to a front surface and a rear surface of a memorial stone at a vertical edge of the memorial stone, for supporting an item (e.g., a flower arrangement) on the memorial stone. The assembly apparatus includes a first clamping arm for placement against the front surface of the memorial stone, second clamping arm for placement against the rear surface of the memorial stone, and a clamping arm support for supporting a first clamping arm in a horizontal orientation and a second clamping arm. The inside surfaces of the respective clamping arms include gripping strips.

The '099 patent also discloses an alternative embodiment of the container assembly apparatus. The alternative arrangement of the assembly apparatus teaches a clamping-pressure-exerting assembly having threaded screws and complementarily threaded open-ended nuts. As disclosed, the threaded screws pass through respective apertures in the second clamping arm, the clamping arm support, and the first clamping arm before they are screwed into the complementary open-ended nuts. In this embodiment, the container and the clamping arm support are preferably a unified, integrated structure. However, no support stand is disclosed, and the clamping arms are adjustable.

U.S. Published Patent Application No. 2008/0308695 discloses a universal vase holder. The vase holder generally includes a base, a brace attached to the base, a first telescoping member telescopically attached to the base, a second telescoping member telescopically attached to the base, a first arm attached to the first telescoping member and extending rearward from the first telescoping member, a second arm attached to a second telescoping member and extending rearwardly from the second telescoping member, and a support attached to the base and extending forward from the base. Adjustment means are arranged at respective ends of the first arm and the second arm-which are disclosed as screws. The vase holder may further comprise means for locking the first telescoping member at a fixed degree of extension and means for locking the second telescoping member at a fixed degree of extension. The means are described as a threaded hole and set screw or any other suitable mechanism for locking the telescoping members in place once the telescoping members are extended to the desired length. The '695 application fails to disclose a clamp having fixed arms or a holster arranged within the vase holder.

Therefore, there is also a long-felt need for a removable container that can be attached directly to the headstone marker in a removable and adjustable manner, where the attachment means are arranged such that they also avoid damaging the expensive material and artistic attributes of the headstone while not obstructing the artistic attributes present on a face of the headstone.

In many situations, headstones are decorated with flags or by a floral bouquet, or even with a single flower, such as a rose. Normally, flags are inserted directly into the ground proximate the headstone or require a special holster to be attached to the headstone—the same is true for single flowers, which may be laid down directly on the headstone, risking being displaced onto the ground.

Therefore, there is a further long-felt need for a removable container that can be directly attached to the headstone marker that not only includes at least one planter but also contains at least one holster arranged to display, in an upright position, either a flag, a bouquet or a single flower.

Lastly, there is a necessity for a container that can be removably attached to a headstone, where the headstone has lip or shelf of a base is entirely too small to support decorations or planters therein, where the container includes a cantilever support arranged to engage the lip or shelf of the base to prevent the container from falling over.

### SUMMARY

According to aspects illustrated herein, the present invention generally comprises a removable planter assembly for a headstone including a planter including a floor and at least one wall extending from the floor forming a container portion therein, a holster extending from the floor, a tubular member extending from the floor and arranged within the holster, a U-shaped clamp extending from an outside surface of the at least one wall, the U-shaped clamp having a mounting member secured to the at least one wall and a pair of arms extending from the mounting member, one of the pair of arms having at least one fixed securement mechanism secured thereon, the at least one fixed securement mechanism arranged proximate a terminating end of the arm and further arranged on an internal surface of the arm, one of the pair of arms having at least one adjustable securement mechanism secured therein, the at least one adjustable securement mechanism arranged proximate a terminating end of the arm, and a support stand extending from an external surface of the floor.

In some embodiments, the present invention generally comprises a removable planter assembly for a headstone, comprising a planter including a floor and at least one wall extending from the floor forming a container portion therein, a holster extending from the floor, a tubular member extending from the floor and arranged within the holster, the tubular member includes a partial through-bore therein, a U-shaped clamp extending from an outside surface of the at least one wall, the U-shape clamp having a mounting member secured to the at least one wall and a pair of arms extending from the mounting member, one of the pair of arms having at least one fixed securement mechanism secured thereon, the at least one fixed securement mechanism arranged proximate a terminating end of the arm and further arranged on an internal surface of the arm, one of the pair of arms having at least one adjustable securement mechanism secured therein, the at least one adjustable securement mechanism arranged proximate a terminating end of the arm, at least one support stand extending from an external surface of the floor, and a cap member having an aperture therein, the cap member arranged to be seated within an opening of the holster.

In further embodiments, the present invention may generally comprise a removable planter assembly for a headstone, the assembly comprising a planter including a floor and at least one wall extending from the floor forming a container portion therein, a U-shaped clamp extending from an outside surface of the at least one wall, the U-shape clamp having a mounting member secured to the at least one wall and a pair of arms extending from the mounting member, one of the pair of arms having at least one fixed securement mechanism secured thereon, the at least one fixed securement mechanism arranged proximate a terminating end of the arm and further arranged on an internal surface of the arm, one of the pair of arms having at least one adjustable securement mechanism secured therein, the at least one adjustable securement mechanism arranged proximate a terminating end of the arm, and at least one support stand extending from an external surface of the floor.

In other arrangements, the present invention may generally comprise a removable planter assembly for a headstone, the assembly comprising a planter including a container having a floor, the floor having a width, and a support stand, rectangular in shape, extending downwardly from an external surface of the floor, the support stand having a width, which support stand width is less than the width of the floor, wherein the width of the support stand is less than or equal to approximately 25% of the width of the container floor. The planter is supported in a cantilever manner atop the support stand. The support stand has a planar bottom surface arranged to contact a base of a headstone, the planar bottom surface is also arranged to be parallel to and spaced apart from the floor of the container.

In some embodiments, the floor of the container of the present invention may have at least a pair of L-shaped brackets extending therefrom, specifically, extending from a bottom surface of the floor, whereas the pair of L-shaped brackets are arranged to hold a cap of the present invention therein.

In other embodiments, the present invention may include two different caps, a first cap having an aperture therein and a second cap without the aforementioned aperture, whereas a floor of a container of the present invention may include a pair of L-shaped brackets and a T-shaped bracket disposed between the pair of L-shaped brackets, all of the brackets are arranged to extend from a bottom surface of the floor and the brackets are arranged to hold the aforementioned caps therein when not in use.

These and other objects, features, and advantages of the present invention will become readily apparent upon a review of the following detailed description of the invention, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a perspective view of the present invention attached to a headstone marker;

FIG. 2 is a side view of the present invention and the headstone marker shown in FIG. 1;

FIG. 3A is a partial top view of the present invention and the headstone marker shown in FIG. 1;

FIG. 3B is a partial front view of the present invention and the headstone marker shown in FIG. 1;

FIG. 4 is a perspective view of the invention shown in FIG. 1;

FIG. 5 is a skeleton perspective view of the invention shown in FIG. 4;

FIG. 6 is a rear view of the invention shown in FIG. 4;

FIG. 7A is a cross-sectional view taken generally along line 7-7 in FIG. 4;

FIG. 7B is an enlarged view taken from FIG. 7A;

FIG. 8 is a cross-sectional view taken generally along line 8-8 in FIG. 1;

FIG. 9A is a front view of an alternative embodiment of the invention shown in FIG. 1; and,

FIG. 9B is a bottom view of the invention shown in FIG. 9A.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” or “at least one of” is used herein.

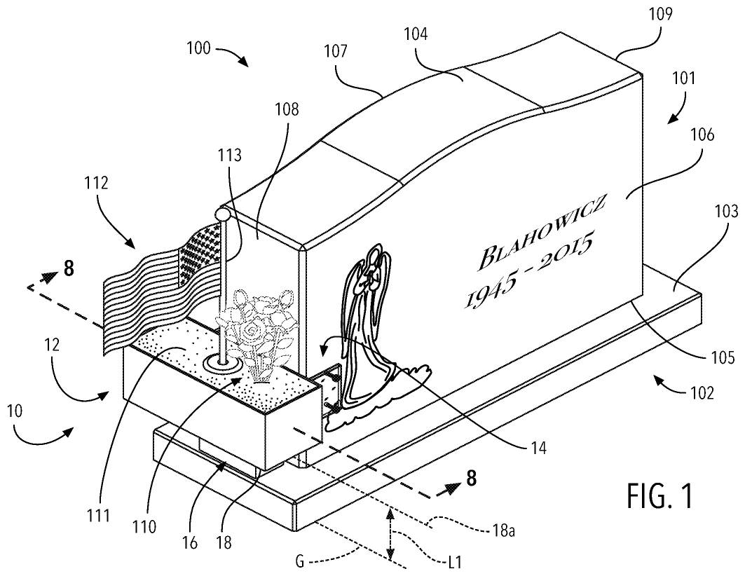

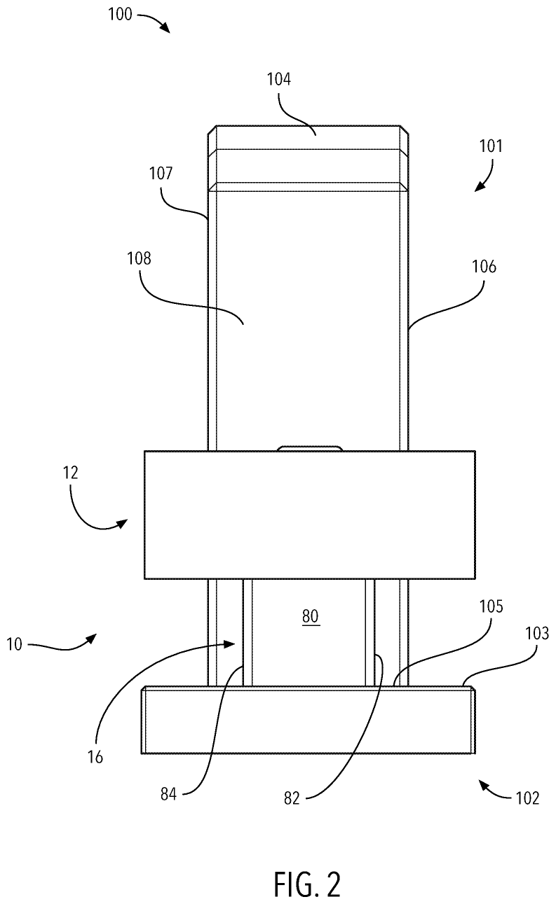

The following description should be taken in view of FIGS. 1 through 3B, which respectively show a perspective view, a side view, a partial top view, and a partial front view of the present invention, planter assembly 100, attached to a headstone, specifically headstone 100, and more specifically, headstone marker 101. As shown, headstone marker 101 is attached to, or at least placed on, base 102 of headstone 100. Base 102 has lip portion 103 (or shelf portion) which extends past the external perimeter of headstone marker 101. Headstone marker 101 includes top face 104, bottom surface 105 (resting on base 102), front face 106, back face 107, first side face 108, and second side face 109.

Planter assembly 10 is shown secured to headstone marker 101 proximate first side face 108. Planter assembly 10 generally includes container 12, bracket 14, and support stand 16. Bracket 14 is arranged to substantially clamp onto and removably attach to headstone marker 101; specifically bracket 14 engages at least front face 106 and back face 107, and, in some arrangements, may also abut first side face 108. It should be noted that bracket 14 may also be arranged proximate second side face 109. Support stand 16 extends from container 12 and is arranged to rest on lip portion 103 of base 102. Container 12 is arranged to hold soil 111 such that floral arrangement 110 can be planted therein. Container 12 is further arranged to hold decorative arrangement 112, specifically, support 113 (e.g., post, pole, stem, etc.) of decorative arrangement 112 therein. Decorative arrangement 112 can take a plurality of different forms, from a flag having a flagpole, a single stemmed flower, or multiple flower stems, post and/or poles extending from photo arrangements and the like.

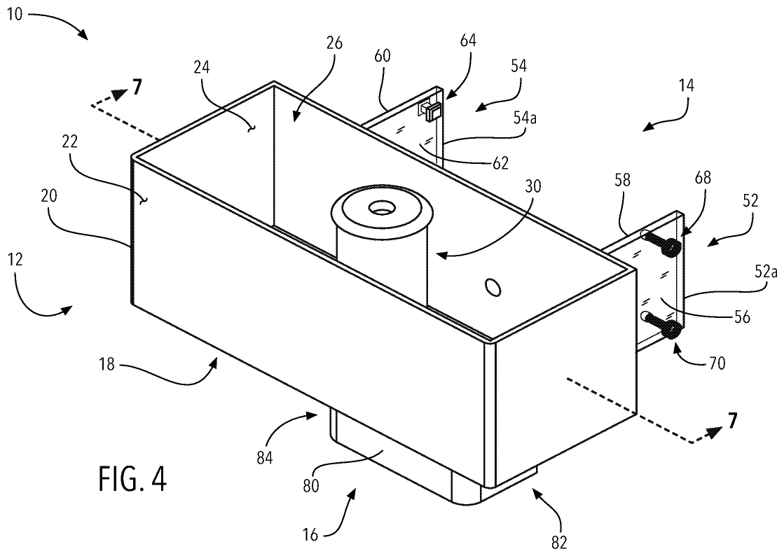

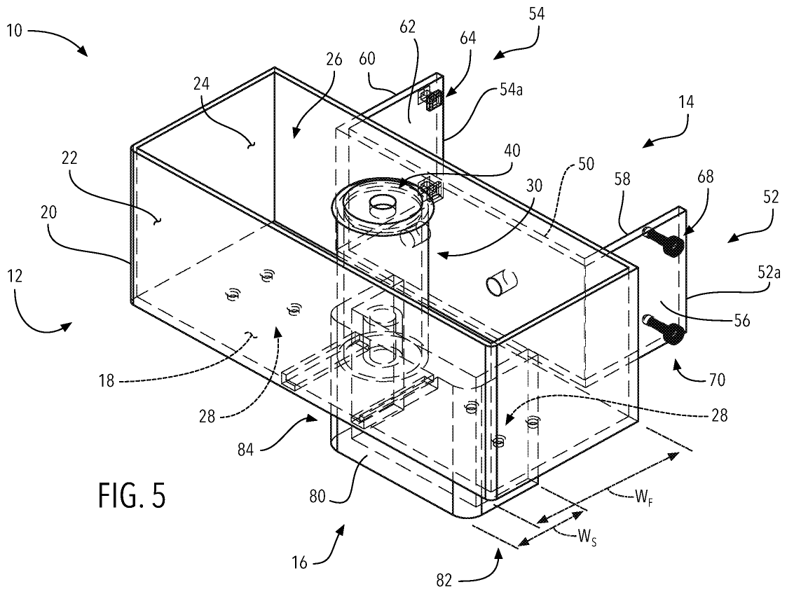

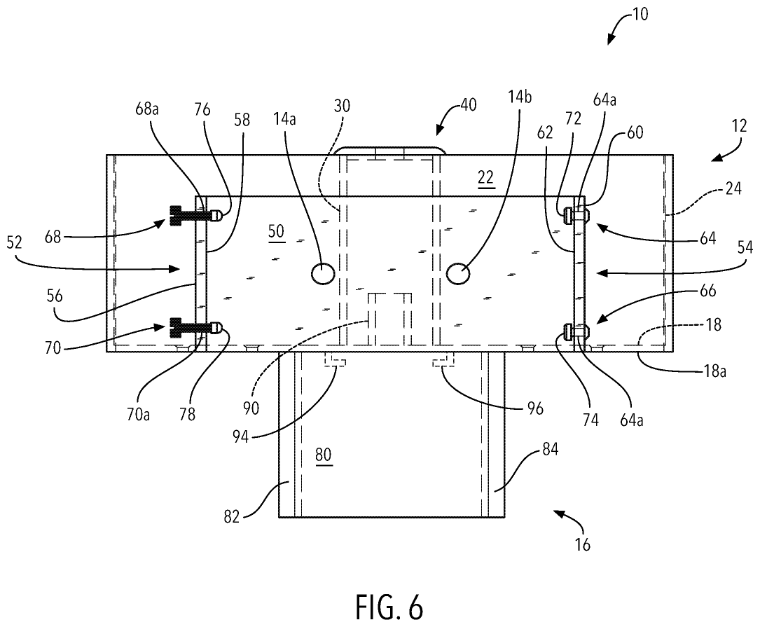

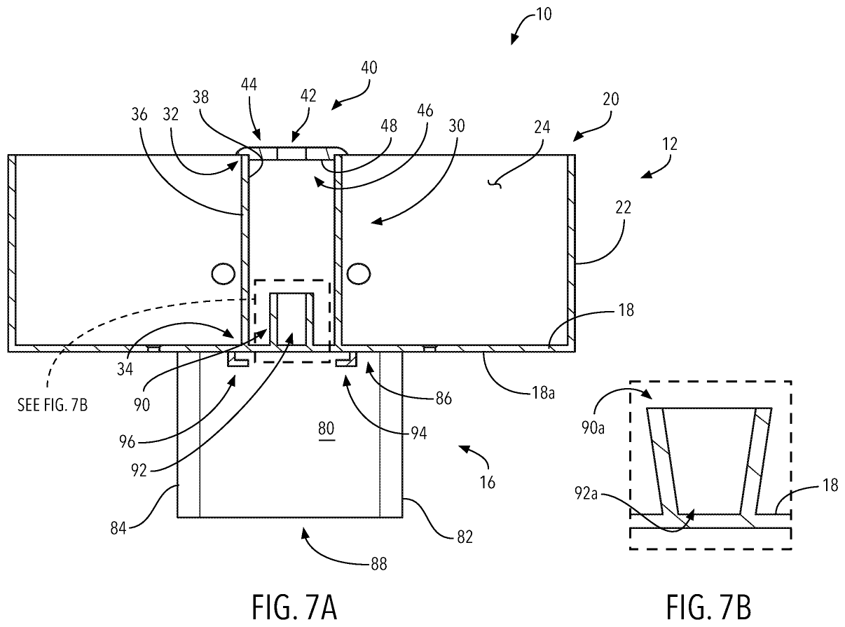

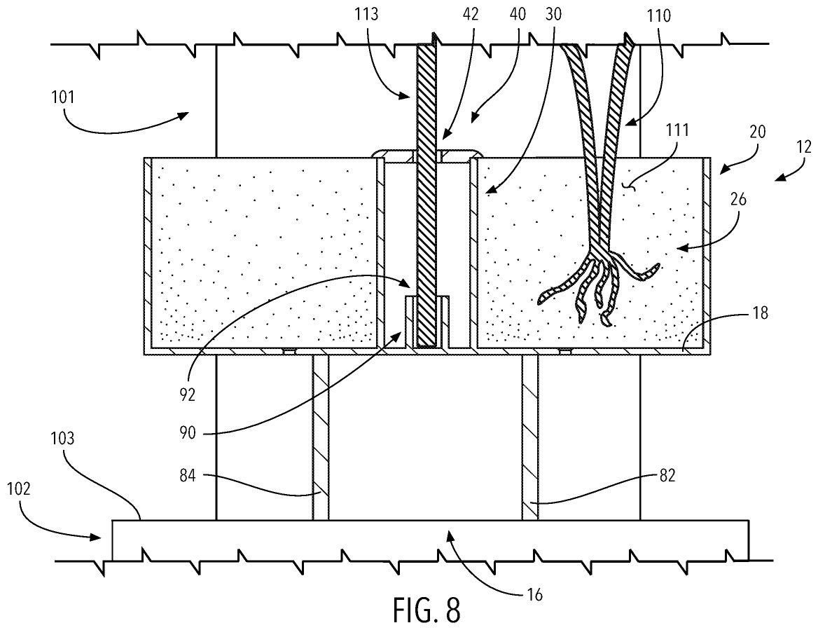

The following description should be taken in view of the aforementioned figures and FIGS. 4 through 8 which generally depict planter assembly 10 removed from headstone marker 101. Specifically, FIGS. 4 and 5 illustrate a perspective view of planter assembly 10, FIG. 6 illustrates a rear view of the same, FIGS. 7A and 8 illustrate cross-sectional views of assembly 10 taken along line 7-7 in FIG. 4 and line 8-8 in FIG. 1, respectively. Lastly, FIG. 7B illustrates an alternative arrangement of the tubular member disposed within the holster of the present invention.

Container 12 of planter assembly 10 generally comprises floor 18 and wall 20 extending from floor 18, whereas wall 20 creates cavity 26 within container 12. Wall 20 includes external surface 22 and internal surface 24. Holster 30 extends from floor 18, specifically from an upper surface of floor 18, and is arranged within cavity 26 formed by wall 20. Generally, holster 30 is arranged at substantially a center point of floor 18 and is configured to extend to a top edge of wall 20. Cap 40 is arranged to be seated within holster 30. In some embodiments, floor 18 includes plurality of drainage apertures 28 therein. Tubular member 90 is also arranged to extend from floor 18 and is arranged within holster 30.

Adverting back to FIG. 1, floor 18 (of container 12) includes bottom surface 18a. It should be noted that ground surface G and bottom surface 18a have length L1 therebetween, whereas length L1 represents a minimum height, i.e., at least 8 inches, between ground surface G and bottom surface 18a, such that mowers, trimmers, and the like, will not hit or contact container 12.

As shown in FIGS. 6 and 7A, in some embodiments, bottom surface 18a of floor 18 of container 12 may include L-brackets 94 and 96 extending therefrom. L-brackets 94 and 96 are primarily arranged to hold cap 40 when not in use.

Holster 30 includes top end 32, bottom end 34, whereas bottom end 34 extends from floor 18, external surface 36, and internal surface 38. In some arrangements, holster 30 resembles a hollow cylinder, although different shaped configurations may be utilized. Cap 40 includes aperture 42, top end 44, bottom end 46, and protruding portion 48 extending from bottom end 46. Aperture 42 is arranged to extend entirely through cap 40, i.e., open on both of top end 44 and through protruding portion 48. Protruding portion 48 is arranged to be at least partially seated within internal surface 38 of holster 30. Protruding portion 48 may be arranged to frictionally abut internal surface 38 when seated within holster 30. Tubular member 90 is essentially a hollow cylinder extending from floor 18 and is arranged within internal surface 38 of holster 30, proximate bottom end 34. Tubular member 90, like holster 30, may also take a variety of different configurations, e.g., rectangular, triangular, etc. Tubular member 90 includes through-bore 92 therein. Through-bore 92 extends through the entirety of tubular member 90. however, floor 18 closes, or seals, one end of through-bore 92. Through-bore 90 has a center point that is substantially colinear in relation to a center point of holster 30 and a center point of aperture 42 of cap 40.

As shown in FIG. 7B, tubular member 90 may be alternatively arranged as frustoconical extension 90a which has frustoconical through-bore 92a therein. The tapered arrangement of frustoconical extension 90a. i.e., a larger diameter opening away from floor 18. makes it easier to insert items from display therein via a funneling arrangement.

Bracket 14 is fixedly secured to external surface 22 of wall 20. Bracket 14 may be fixedly secured to external surface 22 of wall 20 via fasteners 14a and 14b, i.e., rivets, or the like. Alternatively, bracket 14 may be removably secured to external surface 22 of wall 20 via fasteners 14a and 14b. i.e., screws, or snap-fit means. Bracket 14 generally includes attachment support 50 (i.e., a mounting member to the wall of the container), first arm 52 extending from one end of attachment support 50 and second arm 54 extending from an opposite end of attachment support 50. Bracket 14 essentially is a U-shaped clamp. First arm 52 includes end 52a, external surface 56, and internal surface 58. Proximate end 52a is first adjustable attachment aperture 68a and second adjustable attachment aperture 70a, arranged to accept first adjustable attachment member 68 and second adjustable attachment member 70 therein, respectively. Second arm 54 includes end 54a, external surface 60, and internal surface 62. Proximate end 54a is first fixed attachment aperture 64a and second fixed attachment aperture 66a. arranged to accept first fixed attachment member 64 and second fixed attachment member 66 therein, respectively. First gripping tip 76 and second gripping tip 78 are arranged on ends of first adjustable attachment member 68 and second adjustable attachment member 70, proximate internal surface 58 of first arm 52, respectively. First gripping portion 72 and second gripping portion 74 are arranged on ends of first fixed attachment member 64 and second fixed attachment member 66, proximate internal surface 62 of second arm 54, respectively.

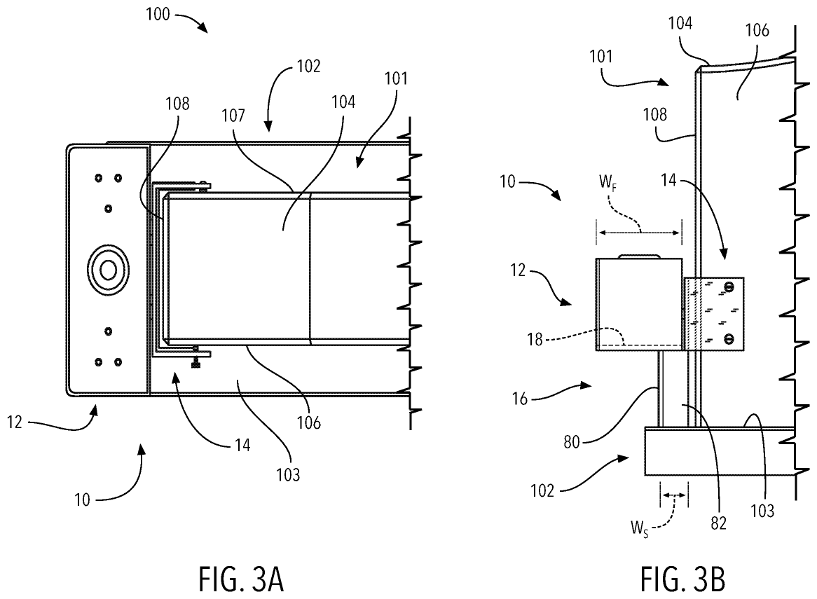

First adjustable attachment member 68 and second adjustable attachment member 70 may be threaded screws having tips covered by first gripping tip 76 and second gripping tip 78, respectively. First adjustable attachment member 68 and second adjustable attachment member 70 may be tightened or loosened to respectively engage or release tension applied to the front and/or the back faces of the headstone marker (generally shown by bracket 14 attached to headstone marker 101 in FIG. 3A). First gripping tip 76 and second gripping tip 78 may be comprised of rubber, or another material having a high coefficient of friction to securely hold bracket 14 to the headstone marker (when tightened thereon). First fixed attachment member 64 and second fixed attachment member 66 are essentially protruding pieces that frictionally abut and engage the back face and/or the front face of the headstone marker (generally shown by bracket 14 attached to headstone marker 101 in FIG. 3A). First gripping portion 72 and second gripping portion 74 may be rubberized end pieces, or another material having a high coefficient of friction, allowing the gripping portions to securely abut the respective face of the headstone marker. While first fixed attachment member 64 and second fixed attachment member 66 are abutting one of the faces of the headstone marker, first adjustable attachment member 68 and second adjustable attachment member 70 are thereby tightened, thereby frictionally and forcibly abutting the opposite face of the headstone marker, thusly securing bracket 14 (i.e., planter assembly 10) to the headstone marker in a removable manner—generally illustrated in FIGS. 1 through 3B.

In a preferred embodiment, bracket 14 (i.e., mounting member 50, first arm 52, and second arm 54) are substantially transparent. Headstone marker 101 may include text, inscription, design, picture, and/or symbol on at least of faces 106 and 107 (as generally shown in FIG. 1). Constructing bracket 14 is preferably made of a transparent material, allowing the aforementioned images, text, symbols, etc., on the respective faces of headstone marker 101, to be unobstructed by at least first arm 52 and second arm 54. As such, bracket 14 could be comprised of a transparent, or at least a translucent, plastic, or other like material. It should be appreciated that, in some embodiments, bracket 14 may be made of an opaque material, similar in color to that of the headstone, especially in those cases where it would not obstruct the view of an inscription on the headstone.

Support 16 is a support stand for container 12, essentially keeping container 12 in an upright position when planter assembly 10 is attached to the headstone marker. Thusly, support 16 creates a vertical distance between base 102 and container 12. Support 16 includes top end 86, bottom end 88, first wall 80, second wall 82 extending from one end of first wall 80, third wall 84 extending from the opposite end of first wall 80. As shown, support 16 essentially is configured as a U-shaped member, whereas bottom end 88 rests on the base of the headstone and top end 86 (of at least one of first wall 80, second wall 82, and/or third wall 84) extends from a lower surface of floor 18, i.e., the surface opposite of a top surface of floor 18 that holster 30 extends from. In some embodiments, attachment support 50 of bracket 14 may also be attached to top 86 of support 16.

As illustrated in FIG. 3B, support 16 is a cantilever support for container 12 of planter assembly 10, specifically walls 82 and 84 of support 16, i.e., floor 18 of container 12 is supported in a direction proximate bracket 14. Due to the size of base 102 (specifically the exposed portion of lip 103) and the size of container 12, container 12 would fall off base 102 (if bracket 14 became disengaged from headstone marker 101) without support 16 arranged as a cantilever support.

As shown in FIGS. 3B and 5, floor 18 of container 12 has width W_{F} and walls 82 and 84 of support 16 have width W_{S}, whereas width W_{F} is greater than width W_{S}. In a preferred embodiment, width W_{S} is approximately 25%, or less, than width W_{F}. In other embodiments, width W_{S} is approximately 50%, or less, than width W_{F}. In any event W_{S} should be less than the width of lip 103.

Support 16 may also be constructed of a transparent material—similar to bracket 14, as described supra. The combination of the ratio of width W_{F} to width W_{S} and/or transparent construction of support 16, allows support 16 to be arranged in a manner with the least visual obstruction, i.e., support 16 is substantially hidden from an individual observing a headstone having the present invention arranged thereon.

As shown in FIGS. 1 and 8, cavity 26 of container 12 of planter assembly 10 is arranged to hold soil 111 therein, allowing floral arrangement 110 to be planted in soil 111—decorating headstone marker 101. Holster 30 in conjunction with tubular member 90 and cap 40 is arranged to removably hold support 113 of decorative arrangement 112. Specifically, support 113 is seated at least partially within through-bore 92 of tubular member 90, within internal surface 38 of holster 30, and within aperture 42 of cap 40. The combination thereof allows planter assembly 10 to be a removably attached decoration accessory for headstone markers. Cap 40 substantially prevents soil 111 from entering holster 30 by essentially covering a space bounded by internal surface 38 of holster 30.

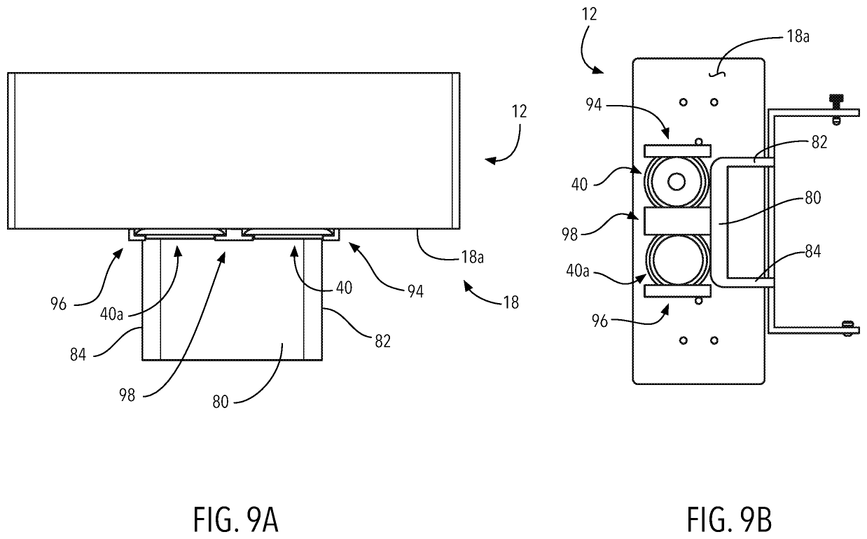

FIGS. 9A and 9B illustrate a front view and a bottom view of an alternative embodiment of the present invention. In other embodiments, as shown in FIGS. 9A and 9B, planter assembly 10 may include caps 40 and 40a, whereas cap 40 is arranged without an aperture. In this embodiment, bottom surface 18a of floor 18 of container 12 includes L-brackets 94 and 96 and T-bracket 98 disposed therebetween. L-bracket 94 and T-bracket 98 are illustrated holding cap 40 therein, whereas L-bracket 96 and T-bracket 98 are illustrated holding cap 40a therein. T-bracket 98 could be alternatively configured as a pair of complimentary L-brackets, i.e., a first inner L-bracket which corresponds with L-bracket 94 and a second inner L-bracket which corresponds with L-bracket 96. It should also be noted that the aforementioned brackets, and alternative configurations could have a tapered arrangement, such that the space created to hold the respective caps therein would decrease in a direction towards first wall 80—thereby creating a frictional securement of the respective cap as it is inserted into the respective pair of brackets for storage.

It should be noted that planter assembly 10 may take the form of various alternative embodiments. For example, bracket 14, specifically arms 52 and 54, could both include the aforementioned adjustable attachment members, i.e., arms 52 and 54 do not include the aforementioned fixed attachment members. Additionally, although the illustrations show a pair of the adjustable attachment members, any suitable number could be used, i.e., 3, 4, etc., to accommodate different size planter assemblies, the same is true for the fixed attachment members. Container 14 could also include additional holsters and respective tubular members. Alternatively, container 14 could be configured within at least one bifurcating wall extending from the internal surface of the wall to create separate cavities within container 14.

As such, support 16, i.e., the support stand, could alternatively be arranged as a single wall extending from floor 18 of container 12. i.e., only wall 82 or 84, or a plurality of individual walls, i.e., only walls 82 and 84, or a cylindrical tube or a plurality of individual tubes, or a plurality of individual trusses, or posts.

Lastly, it should be noted that those in the art will appreciate that any suitable material, now known or hereafter developed, may be used in forming the aforementioned components of the present invention described herein.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

10 Planter assembly
12 Container
14 Bracket
14a Bracket fastener
14b Bracket fastener
16 Support stand
18 Floor
18a Bottom surface
20 Wall
22 External surface
24 Internal surface
26 Cavity
28 Plurality of drainage apertures
30 Holster
32 Top end
34 Bottom end
36 External surface
38 Internal surface
40 Cap
40a Cap
42 Aperture
44 Top end
46 Bottom end
48 Protruding portion
50 Attachment support
52 First arm
52a End of first arm
54 Second arm
54a End of second arm
56 External surface
58 Internal surface
60 External surface
62 Internal surface
64 First fixed attachment member
66 Second fixed attachment member
68 First adjustable attachment member
70 Second adjustable attachment member
72 First gripping portion
74 Second gripping portion
76 First gripping tip
78 Second gripping tip
80 First wall
82 Second wall
84 Third wall
86 Top end
88 Bottom end
90 Tubular extension
90a Frustoconical extension
92 Through-bore
92a Frustoconical through-bore
94 L-bracket
96 L-bracket
98 T-bracket
100 Headstone
101 Headstone marker
102 Base
103 Lip
104 Top face
105 Bottom surface
106 Front face
107 Back face
108 First side face
109 Second side face
110 Floral arrangement
111 Soil
112 Decorative arrangement
113 Support of decorative arrangement 112
G Ground surface
L1 Length
W_{F} Width of floor 18
W_{S} Width of support 16

What is claimed is:

1. A removable planter assembly for a headstone, comprising:
a planter including a floor and at least one wall extending from said floor forming a container portion therein, a holster extending from said floor, a tubular member extending from said floor and arranged within said holster;
a U-shaped clamp extending from an outside surface of said at least one wall, said U-shaped clamp having a mounting member secured to said at least one wall and a pair of arms extending from said mounting member, one of said pair of arms having at least one fixed securement mechanism secured thereon, said at least one fixed securement mechanism arranged proximate a terminating end of said arm and further arranged on an internal surface of said arm, one of said pair of arms having at least one adjustable securement mechanism secured therein, said at least one adjustable securement mechanism arranged proximate a terminating end of said arm; and,
a support stand extending from an external surface of said floor.

2. The removable planter assembly for a headstone recited in claim 1, wherein said tubular member includes a partial through-bore therein, said partial through-bore arranged to accept a decorative member therein.

3. The removable planter assembly for a headstone recited in claim 1, wherein said fixed securement mechanism comprises a protrusion having a gripping portion.

4. The removable planter assembly for a headstone recited in claim 1, wherein said at least one adjustable securement mechanism comprises a threaded screw having a gripping tip.

5. The removable planter assembly for a headstone recited in claim 2 further comprising a cap member having an aperture therein, said aperture of said cap member arranged to accept said decorative member therein, said cap member arranged to be seated within an opening of said holster.

6. The removable planter assembly for a headstone recited in claim 1, wherein said floor of said planter is arranged to have at least one drainage aperture therein.

7. The removable planter assembly for a headstone recited in claim 4, wherein said U-shaped clamp is arranged to be frictionally secured to a headstone marker via tightening of said at least one adjustable securement mechanism.

8. The removable planter assembly for a headstone recited in claim 1, wherein said floor comprises a bottom surface, said bottom surface having a bracket configuration extending therefrom, said bracket configuration selected from a group consisting of:
a pair of L-brackets; and,
a pair of L-brackets and a T-bracket disposed between said pair of L-brackets.

9. The removable planter assembly for a headstone recited in claim 1, wherein said U-shaped bracket is substantially transparent.

10. A removable planter assembly for a headstone, comprising:
a planter including a floor and at least one wall extending from said floor forming a container portion therein;
a U-shaped clamp extending from an outside surface of said at least one wall, said U-shape clamp having a mounting member secured to said at least one wall and a pair of arms extending from said mounting member, one of said pair of arms having at least one fixed securement mechanism secured thereon, said at least one fixed securement mechanism arranged proximate a terminating end of said arm and further arranged on an internal surface of said arm, one of said pair of arms having at least one adjustable securement mechanism secured therein, said at least one adjustable securement mechanism arranged proximate a terminating end of said arm; and,
at least one support stand extending from an external surface of said floor.

11. The removable planter assembly for a headstone recited in claim 10 further comprising:
a holster extending from said floor,
a tubular member extending from said floor and arranged within said holster, said tubular member includes a partial through-bore therein; and,
a cap member having an aperture therein, said cap member arranged to be seated within an opening of said holster.

12. The removable planter assembly for a headstone recited in claim 10, wherein said at least one fixed securement mechanism comprises a protrusion having a gripping portion and said at least one adjustable securement mechanism comprises a threaded screw having a gripping tip.

13. The removable planter assembly for a headstone recited in claim 12, wherein said U-shaped clamp is substantially transparent.

14. A removable planter assembly for a headstone, comprising:
a planter including a container having a floor, said floor having a width; and,
a support stand, rectangular in shape, extending downwardly from an external surface of said floor, said support stand having a width, which support stand width is less than said width of said floor.

15. The removable planter assembly recited in claim 14, wherein said width of said support stand is less than 25% of the width of said floor.

16. The removable planter assembly recited in claim 14 wherein said container is supported in a cantilever manner atop said support stand.

17. The removable planter assembly recited in claim 15, wherein said support stand has a planar bottom surface arranged to contact a base of a headstone, said planar bottom surface also arranged to be parallel to and spaced apart from said floor of said container.

18. The removable planter assembly recited in claim 15 further comprising:
a U-shaped clamp extending from an outside surface of said container, said U-shape clamp having a mounting member secured to said outside surface of said container and a pair of arms extending from said mounting member, one of said pair of arms having at least one fixed securement mechanism secured thereon, said at least one fixed securement mechanism arranged proximate a terminating end of said arm and further arranged on an internal surface of said arm, one of said pair of arms having at least one adjustable securement mechanism secured therein, said at least one adjustable securement mechanism arranged proximate a terminating end of said arm.

19. The removable planter assembly recited in claim 18 further comprising:
a holster extending from said floor;
a tubular member extending from said floor and arranged within said holster, said tubular member includes a partial through-bore therein; and,
a cap member having an aperture therein, said cap member arranged to be seated within an opening of said holster.

20. The removable planter assembly recited in claim 18, wherein said U-shaped clamp is substantially transparent.
